(19) United States
(12) Patent Application Publication
(10) Pub. No.: US 2018/0236444 A1
(43) Pub. Date: Aug. 23, 2018

(54) PROCESS FOR PRODUCING A BURIED MICROFLUIDIC CHANNEL WITH INTEGRATED HEATER

(71) Applicants: Kenton C. HASSON, Rockville, MD (US); Andrea PAIS, Rockville, MD (US); Brian JAMIESON, Rockville, MD (US); Canon U.S. Life Sciences, Inc., Rockville, MD (US)

(72) Inventors: Kenton C. Hasson, Germantown, MD (US); Andrea Pais, Annapolis, MD (US); Brian Jamieson, Severna Park, MD (US)

(73) Assignee: Canon U.S. Life Sciences, Inc., Rockville, MD (US)

(21) Appl. No.: 15/396,807

(22) PCT Filed: Jul. 2, 2015
(86) PCT No.: PCT/US2015/039074

§ 371 Date: Mar. 21, 2017

Related U.S. Application Data
(60) Provisional application No. 62/020,102, filed on Jul. 2, 2014.

(51) Int. Cl. B01L 3/00

(52) U.S. Cl. CPC B01L 3/502707; B01L 2300/0887; B01L 2300/1827; B01L 2300/12; B01L 2300/06

(57) ABSTRACT

A microfluidic chip having integrated heaters and a method for manufacturing the microfluidic chip is provided. Specifically, the microfluidic chip comprises a first substrate having a microchannel formed therein. The second substrate is bonded to the first substrate to encapsulate the microchannel. An integrated heating element, that is hermetically sealed and electrically isolated from the microchannel, is formed on the top surface the second substrate after the first and second substrates are bonded together. A biological reaction can be performed in the microchannel of the microfluidic chip while the fluid in the microchannel is heated by electrical current passing through the integrated heating element.

### CROSS-REFERENCE TO RELATED APPLICATIONS

This application is the national phase of International Patent Application PCT/US2015/039074 filed Jul. 2, 2015, published as WO 2016/004362, which claims the benefit of U.S. Provisional Patent Application Ser. No. 62/020,102, filed on Jul. 2, 2014, which is incorporated herein by reference in its entirety.

### BACKGROUND

### Field of the Invention

The present invention relates to a method of manufacture of microfluidic chips having at least one microchannel. Specifically, the present invention relates to manufacturing microfluidic chips having integrated heating elements that are hermetically sealed (electrically isolate) from the fluid in a microchannel. The present invention also relates to microfluidic chips made by the method described herein having hermetically sealed integrated heating elements. The present invention additionally relates to kits comprising such microfluidic chips.

### Discussion of the Background

Microfluidic chips for conducting chemical and biological reactions have gained widespread acceptance as a tool used for analytical and research purposes. Provided in a variety of sizes, shapes, and configurations, microfluidic chips are employed for numerous chemical and biological applications.

Microfluidic chips having one or more microchannels formed in silicon, glass, or other substrates are well known in the art. Traditional methods of preparing microfluidic chips are as described in Liu et al. 2000. Proc. Natl. Acad. Sci. USA 97(10):5369-5374 and Anderson et al. 2000. Nucleic Acids Res. 28:e60. Liu et al. describes etching of glass wafers in hydrofluoric acid, followed by sputtering of CR and AU layers and the application of an adhesion layer on top of the metallized layers. The wafers were then spin-coated with a photoresist layer and soft-baked before the photoresist was patterned using UV light through a mask that had the required pattern of microfluidic channels. Following development of the photoresist, the exposed metallized layer was etched off and the channel pattern was chemically etched into the glass. The remaining photoresist and metallized layer was removed, holes to access the microchannels were provided by drilling and the wafer was gleaned before being thermally bonded with a second, blank wafer. Anderson et al. describes the use of a cartridge for use in genetic assays that was prepared by computer-controlled machining as is understood in the art, resulting in a cartridge comprising two 0.25 mm thick silicone layers with a 0.01 mm thick mylar layer between them. Although Anderson et al. used screws and a clamping fixture to hold the layers together, they also provide that ultrasonic welding or adhesives can be used.

In many instances, methods for production of microfluidic chips or “lab-on-a-chip” devices currently use principles and tools of semiconductor process equipment. These methods require patterning metal and electronics on silicon, polymer, and glass substrates. Examples of the integrated microfluidic devices are described in Erickson and Li, “Integrated Microfluidic Devices,” Analytica Chimica Acta 2004, 507:11-26, Zhang and Xing, “Survey and Summary: Miniaturized PCR Chips for Nucleic Acid Amplification and Analysis: Latest Advances and Future Trends,” Nucleic Acids Research June 18, 2007, 35(13):4223-37, Haeberle and Zengerle, “Microfluidic Platforms for Lab-on-a-Chip Applications,” Lab Chip Jul. 27, 2007, 7(9):1094-110, Chen et al., “Total Nucleic Acid Analysis Integrated on Microfluidic Devices,” Lab Chip Aug. 9, 2007, 7:1413-23, Weigl et al., “Towards Non-and Minimally Instrumented, Microfluidics-Based Diagnostic Devices,” Lab Chip Oct. 29, 2008, 8(12):1999-2014, and Sharp et al., Chapter 6: Liquid Flows in Microchannels, in The MEMS Handbook, Ed. M. Gad-el-Hak, CRC Press 2001, each of which are incorporated herein in their entirety.

In some cases, direct electrical contact to the fluidic contents of the channel may be desired for sample manipulation (e.g. for heating, mixing, or impedance-based readout, or other function). In such circumstances, a patterned metal electrode or other circuit element makes intimate direct contact to the fluid. For instance, a capillary electrophoresis chip has high voltage electrodes that are in direct contact with the fluid in a microchannel to provide electrical potential across the microchannel. However, sometimes it is desired to electrically heat the fluid, but avoid electrochemical reactions that would result from direct contact between the fluid in the microchannel and electrical elements.

Fabrication of such microfluidic chips requires bonding of two or more glass or silicon substrates to hermetically seal one or more microchannels that are initially formed in one of the substrates. A metallic layer that serves as a heating element may be integrated into the microfluidic chip. To heat the fluid in a microchannel, the heating element should be in a close proximity to the microchannel which implies that the substrate having the heating element should be relatively thin. For example, Dodge (“Microfluidic devices for heterogeneous assays,” Dissertation, 2003) describes a microfluidic chip comprising two substrates, a channel formed in one of these substrates and hermetically sealed by another, and a metallic layer sputtered over the sealing substrate.

Bonding two glass or silicon substrates by using fusion bonding is known in the art, as previously described. However, fusion bonding often results in void or crack formation due to dust particles, non-planarity and differences in thermal coefficient of expansion are very common. Different approaches have been suggested in the art to bond two substrates by fusion bonding thereby avoiding cracking of the thin substrate.

For example, Stjernström (“Method for fabrication of microfluidic systems in glass,” Journal of Micromechanics and Microengineering, Volume 1, Number 1) describes a method for fabricating integrated microfluidic elements in glass. By employing a matrix of underpinning posts and a thin wall, surrounding etched flow channels, an efficient sealing of glass chips substrates to thin cover glass can be accomplished. However, bonding a thin and a thick substrate still presents a challenge and is rather costly and time consuming.

Accordingly, a process for manufacturing a microfluidic chip that allows avoidance of cracks in a thin substrate while performing fusion bonding that results in forming a thin glass layer sealing a microchannel is needed.

Additionally, there is a need for a microfluidic chip having an integrated circuit elements (e.g. a resistors) positioned in close physical proximity to a microchannel, but hermetically sealed (electrically isolated) from the fluid in the microchannel by a high quality transparent insulating layer.

### SUMMARY OF THE INVENTION

The present invention relates to a microfluidic chip having at least one microchannel and a method for producing the microfluidic chip. According to one aspect of the invention, a microchannel and through holes are formed in a first substrate. A second unpatterned substrate having a first surface and a second surface is provided to be attached to the first substrate. Specifically, the first surface of the second substrate is attached to the first substrate to encapsulate the microchannel formed in the first substrate. Then, the second surface of the second substrate is metallized to provide integrated electrical elements. In one embodiment, the method further comprises thinning the second substrate after the second substrate is attached to the first substrate to allow the circuit elements to be formed in close proximity to the fluidic channels.

In yet another aspect of the invention, a microfluidic chip is provided. Specifically, the microfluidic chip comprises a first substrate having a microchannel formed therein, a second substrate bonded to the first substrate to encapsulate the microchannel, and electrical circuit elements. Specifically, the second substrate has a first surface and a second surface, wherein the first surface of the second substrate is bonded to the first substrate. The electrical elements are formed on the second surface of the second substrate by using a metallization process.

Integrated electrical circuit elements are hermetically sealed and electrically isolated from the fluid the microchannel. The fluid in the microchannel is heated by electrical current in the electrical elements. In one embodiment, fluidic channels are etched using wet or dry (plasma) etching.

In yet another embodiment of the present invention, the first or second substrate is made of glass, silicone, borosilicate glass, pyrex, or polymer. The first and second substrate may be made of the same or different materials. In yet another aspect of the invention, the second substrate is attached to the first substrate by a fusion bond with high temperature anneal. The electrical elements may comprise a platinum layer and gold pads.

### BRIEF DESCRIPTION OF THE DRAWINGS

The accompanying drawings, which are incorporated herein and form part of the specification, illustrate various embodiments of the subject matter of this disclosure. In the drawings, like reference numbers indicate identical or functionally similar elements.

FIG. 1 illustrates a method for manufacturing a microfluidic chip with isolated electrical elements according to the present invention.

FIG. 2 is a flow diagram detailing the method of the present invention for manufacturing a microfluidic chip with isolated electrical elements according to the present invention.

FIG. 3 is a flow diagram detailing an exemplary process in accordance with the present invention.

### DETAILED DESCRIPTION OF PREFERRED EMBODIMENTS

The present invention has several embodiments and relies on patents, patent applications, and other references for details known in the art. Therefore, when a patent, patent application, or other reference is cited or repeated herein, it should be understood that it is incorporated by reference in its entirety for all purposes as well as for the proposition that is recited.

The present invention relates to microfluidic chips having at least one microchannel(s) where biological reactions can be performed. Microchannels are generally understood in the art to mean a channel having dimensions corresponding to a depth and width of between 1 μm and 1 mm. To control the temperature of the fluid in a microchannel, heating elements may be integrated in the microfluidic chip. More specifically, the present invention relates to a method for manufacturing a microfluidic chip having at least one microchannel and integrated electrical elements that are hermetically isolated from the fluid in the microchannel and which can serve as resistive heating elements.

It is noted that microfluidic chips of the present invention may be made using a variety of techniques used in semi-conductor manufacturing as well as in biological chip and cartridge manufacturing. For instance, reference is made to US Patents and Published Applications U.S. Pat. No. 6,236,447, 2009/0117669, 2007/0111250, 2004/0171043, 2003/0087503, and 2003/0151144, which are incorporated herein in their entirety.

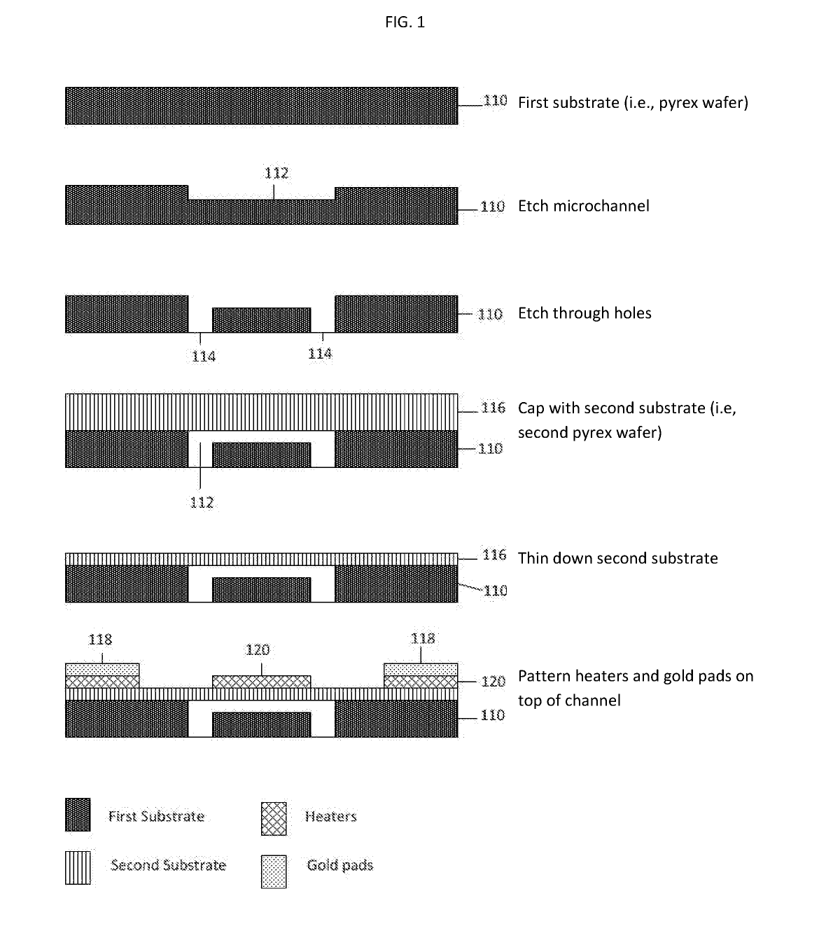

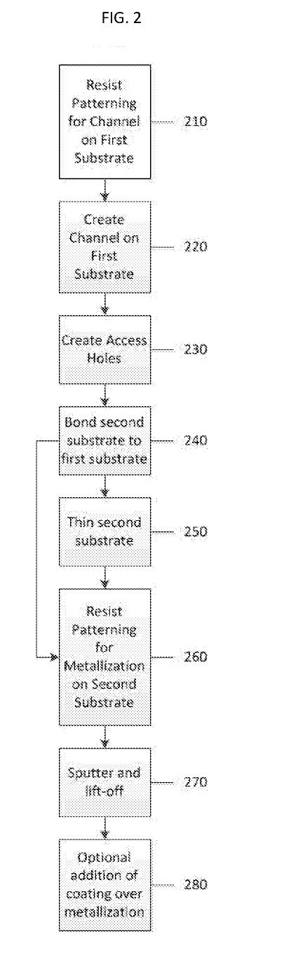

FIG. 1 illustrates a method for producing a microfluidic chip comprising a microchannel where biological reactions are performed, and FIG. 2 provides a flow chart of particular steps of the method. A substrate (wafer) 110 is provided, having a first and second surface. In step 220, at least one microchannel 112 is created by removal of a portion of the first surface of the substrate 110. The substrate 110 may be made of, but is not limited to quartz, glass, polymer, pyrex, silicon, or borosilicate glass. Substrate 110 may be of any thickness sufficient to support the depth of the microchannel 112 to be created, although typical thicknesses may range from 100 μm to 1000 μm. Those of skill in the art will recognize other suitable materials and other suitable thicknesses for use in the substrate 110. In one embodiment, substrate 110 is optically transparent. Microchannel 112 may have a square, rectangular, trapezoidal or other cross-sectional shape. Microchannel 112 has cross sectional dimensions that are from about 1 μm to about 1 mm. In one non-limiting embodiment, microchannel 112 has a width of from about 1 μm to about 1 mm, alternatively from about 100 μm to about 500 μm, alternatively from about 150 μm to about 250 μm, further alternatively from about 180 μm to about 200 μm. In another non-limiting embodiment, microchannel 112 has a depth of from about 1 μm to about 1 mm, alternatively from about 5 μm to about 500 μm, alternatively from about 10 μm to about 100 μm, alternatively from about 15 μm to about 50 μm, further alternatively from about 20 μm to about 25 μm. One of skill in the art will recognize that the length of the microfluidic channel is dependent on the overall size of the microchip and the functionality associated with the microchannel, such that the length of the microchannel is not otherwise constrained.

A plurality of microfluidic channels 112 extending across the first substrate 110 can be formed. In step 210, microfluidic channel 112 formation can be preceded by a lithographic or other similar process in order to provide resist patterning for the microfluidic channel 112 on the substrate 110. For instance, the first surface of the substrate 110 can be coated with a photoresist and be patterned with UV light through a mask, wherein the mask provides the pattern of the microfluidic channel 112. Those of skill in the art will readily know and understand those photoresists that would be appropriate for such an application, for instance, an ultraviolet photosensitive organic material, and would otherwise readily understand the process. Those of skill in the art may utilize other alternative processes including molds, etc. for providing the microfluidic channel 112 pattern on the substrate 110.

In one non-limiting embodiment, the resist patterning followed by etching by using wet or dry etching. Wet etching can indicate chemical etching using a liquid, while dry etching may utilize a gas, such as in reactive ion etching or plasma etching. In another embodiment, the microchannel 112 can formed by mechanical abrasion, including sandblasting or powder blasting. Other methods may include ion beam ablation, laser ablations, or some combination thereof. Such methods of channel formation are well known to those of skill in the art, and the appropriate selection of a particular method is within the scope of standard practice for one of skill in the art.

In the next step 230, access holes 114 are created in the substrate 110 to allow the introduction of fluid into the microchannel 112 from an external source. In one embodiment, the access holes 114 are created 230 between the microchannel 112 and the second surface of the substrate 110. In one embodiment, the holes 114 are formed by etching, as described above, or by drilling. Other methods for forming the access holes 114 may include ion beam ablation or laser ablation. Next, in step 240 a second blank (unpatterned) substrate 116 having a first and second surface is attached or bonded to the first substrate 110 to encapsulate microchannel 112 and complete the channel formation process. Such attachment occurs by attaching the second surface of the substrate 116 to the first surface of the substrate 110. The substrate 116 may be formed of quartz, glass, polymer, pyrex, silicon, or borosilicate glass. Substrate 116 may be of any thickness, although typical thicknesses may range from about 100 μm to about 1000 μm. Substrates 110 and 116 can be made of the same or different materials. In one non-limiting embodiment, substrates 110 and 116 are attached to each other. Attachment of substrates 110 and 116 may be accomplished by any means known in the art, including by a thermal or fusion bond.

After the first surface of the first substrate 110 and the second surface of the second substrate 116 are bonded, in the next step 250, the first surface of the second substrate 116 is optionally thinned to allow circuit elements to be formed in close proximity to the microchannel 112. Bonding the first substrate 110 to the second substrate 116 prior to thinning the second substrate 116 allows the bond to be a fusion bond with high temperature anneal. Using the fusion bond for two relatively thick substrates 110 and 116 allows avoiding formation of cracks and voids in the first and second substrates 110 and 116.

In one embodiment, the thinning process is performed by using one or more of wafer lapping, mechanical grinding and/or polishing, wet etching, dry etching, ion beam ablation, laser ablation, or any combinations thereof. In one non-limiting embodiment, the thinned second substrate 116 has a final depth of under about 100 μm. In a further embodiment, the thinned second substrate 116 has a final depth of about 2 μm to about 50 μm, or about 10 μm. In the next step 260, one or more metal layers 118 and 120 are patterned on the first surface of the thinned second substrate 116 using standard processes including, but not limited to, photolithography. In the next step 270, the metal is deposited using techniques known to those of skill in the art, including but not limited to, sputter and lift-off. For instance, U.S. Pat. No. 5,908,319 (which is incorporated by reference herein) describes a method of using photoresists in semiconductor manufacturing which can be equally applied to the present invention. The metal deposited in one or more layers 118 and 120 may be one or more of gold, platinum, aluminum, chrome, titanium, copper, silver, nickel and the like, including alloys and mixtures thereof

In one embodiment, the one or more metal layers formed on the first surface of second substrate 116 may comprise a platinum layer 120 across the first surface of these second substrate 116 and gold pads 118 placed on top of the platinum layer 120 on those portions of substrate 116 outside of the microchannel 112. Circuit elements controlling the temperature of the fluid in the microchannel 112 are based on the patterned metal layers 118 and 120. The metal layers 118 and 120 may therefore be formed from any suitable resistive material that demonstrates good response to temperature and is capable of being used as a heater. Suitable metal layer materials include, but are not limited to, those described above, including platinum, and nickel.

In a further step 280, an optional layer of resin, polymer, or other suitable material may be coated over the metal layers 188 and/or 120. In one embodiment, the coating acts as an insulator. In another embodiment, the coating acts as a physical protectant.

Accordingly, a reaction fluid may be introduced into the microchannel 112 from an external source. The temperature of the fluid in the microchannel 112 is controlled by the metal layer 118 that serves as a resistive heating element. All circuit elements based on the heating elements 118 and gold pads 120 are hermetically isolated from the reaction fluid in the microchannel 112 such that electrochemical reactions in the microchannel 112 can be avoided.

Bonding the first substrate 110 to the second substrate 116 prior to metallization allows the bond to be a fusion bond with high temperature anneal, which will effectively turn the two separate substrates (wafers) 110 and 116 into a single annealed substrate.

One of the advantages of the method as described above is that the quality of isolation between the circuit elements and the fluidic channel could be substantially improved over other methods, allowing for greater device reliability and longevity.

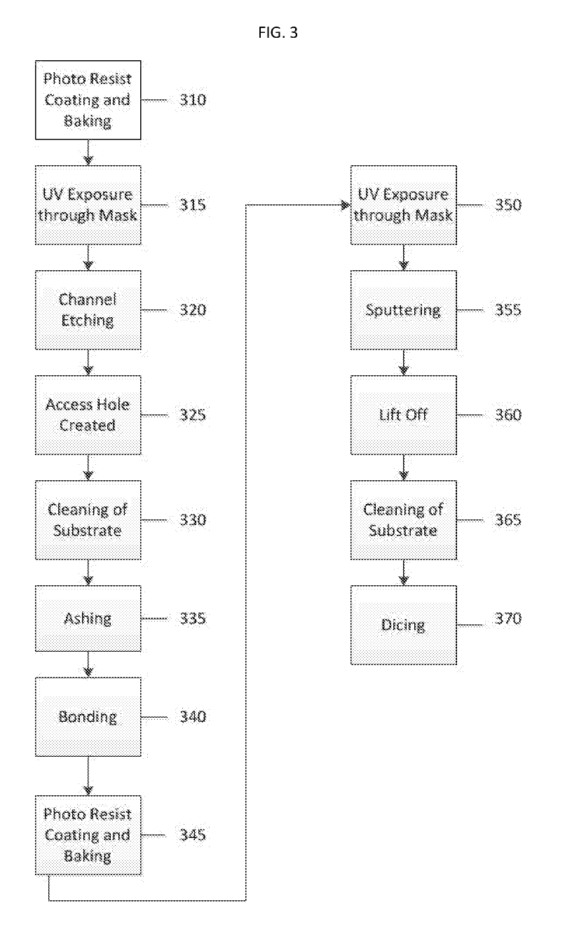

FIG. 3 provides an example method of preparing a microfluidic chip according the present invention including the steps of: 310 adding a photoresist coating to a first substrate 110 and curing or baking substrate 110; step 315, exposing the photoresist coating, including but not limited UV light exposure, through a mask, wherein the mask is provided with the pattern of microchannels 112 to be provided in the substrate 110; step 320, creating the microchannels 112 in substrate 110 by processes including but not limited to etching; step 325, creating one or more access holes 114 in the substrate 114 by processes including but not limited to drilling or laser ablation; step 330, cleaning the substrate; step 340, ashing (oxygen reactive etching) to remove the residual photoresist and or any film coating; step 350, bonding the first side of the substrate 110 to the second side of the substrate 116; optionally thinning the first side of the substrate 116 as in 250 by processes including but not limited to grinding or etching; step 345, adding a photoresist coating to a first side of the second substrate 116 and curing or baking substrate 116; step 350, exposing the photoresist coating, including but not limited UV light exposure, through a mask, wherein the mask is provided with the pattern of metallization to be provided on the substrate 116; step 355, sputtering the one or more metals onto the substrate 116; step 360, lifting off that portion of the photoresist layer that was exposed and hardened such that the metallization on the hardened photoresist layer is also removed, leaving the metal behind in portions of the substrate 116 that were not exposed through the mask; and step 365, cleaning of the substrate. In certain non-limiting embodiments, the methods of the present invention can be performed using large sheets of substrate 110 and substrate 116, so that many microfluidic chips are prepared at once. In such an embodiment, step 365 is then followed by step 370, in which the large sheets are diced into individual microfluidic chips.

In a further embodiment of the present invention, there is provided kits for biological assays that comprise microfluidic chips as described herein and as prepared by the methods described herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

While the subject matter of this disclosure has been described and shown in considerable detail with reference to certain illustrative embodiments, including various combinations and sub-combinations of features, those skilled in the art will readily appreciate other embodiments and variations and modifications thereof as encompassed within the scope of the present disclosure. Moreover, the descriptions of such embodiments, combinations, and sub-combinations is not intended to convey that the claimed subject matter requires features or combinations of features other than those expressly recited in the claims. Accordingly, the scope of this disclosure is intended to include all modifications and variations encompassed within the spirit and scope of the following appended claims.

1. A method for producing a microfluidic chip comprising the steps of:
creating a microchannel in a first substrate;
providing a second substrate having a first surface and a second surface;
attaching the first surface of the second substrate to the first substrate to encapsulate the microchannel; and,
metalizing the second surface of the second substrate to provide an integrated electrical element.

2. The method of claim 1, wherein the integrated electrical element is hermetically sealed from the microchannel.

3. The method of claim 1, wherein the first or second substrate comprises glass, silicone, or a polymer.

4. The method of claim 3, wherein the first and second substrate comprise the same material.

5. The method of claim 3, wherein the first and second substrate comprise different materials.

6. The method of claim 3, wherein at least one of the first and second substrates comprise borosilicate glass.

7. The method of claim 1, wherein the second substrate is attached to the first substrate by a fusion bond with high temperature anneal.

8. The method of claim 1, wherein metalizing the second substrate comprises photolithic metal patterning.

9. The method of claim 1, further comprising thinning the second substrate after the second substrate is bonded to the first substrate.

10. The method of claim 1, wherein electrical elements comprise a platinum layer and gold pads.

11. The method of claim 1, wherein fluid in the microchannel is heated by electrical current in the electrical elements.

12. The method of claim 1, wherein the microchannel is created by wet or dry etching.

13. A microfluidic chip comprising:
a first substrate having a microchannel formed therein;
a second substrate having a first surface and a second surface, wherein the first surface of the second substrate is bonded to the first substrate to encapsulate the microchannel; and
electrical elements formed on the second surface of the second substrate by using a metallization process.

14. The microfluidic chip of claim 13, wherein the integrated electrical element is hermetically sealed from the microchannel.

15. The microfluidic chip of claim 13, wherein the first or second substrate comprises glass, silicone, or a polymer.

16. The microfluidic chip of claim 15, wherein the first and second substrate comprise the same material.

17. The microfluidic chip of claim 15, wherein the first and second substrate comprise different materials.

18. The microfluidic chip of claim 15, wherein at least one of the first and second substrates comprise borosilicate glass.

19. The microfluidic chip of claim 13, wherein the second substrate is attached to the first substrate by a fusion bond with high temperature anneal.

20. The microfluidic chip of claim 13, wherein metalizing the second substrate comprises photolytic metal patterning.

21. The microfluidic chip of claim 13, further comprising thinning the second substrate after the second substrate is bonded to the first substrate.

22. The microfluidic chip of claim 13, wherein electrical elements comprise a platinum layer and a gold layer.

23. The microfluidic chip of claim 13, wherein fluid in the microchannel is heated by electrical current in the electrical elements.

24. The microfluidic chip of claim 13, wherein the microchannel is created by wet or dry etching.

25. A method for producing a microfluidic chip comprising the steps of:
creating a microchannel in a first substrate;
providing a second substrate having a first surface and a second surface;
attaching the first surface of the second substrate to the first substrate to encapsulate the microchannel;
thinning the second substrate after the second substrate is attached to the first substrate; and
metalizing the second surface of the second substrate to provide an integrated electrical element.

26. A microfluidic chip comprising:
a first substrate having a microchannel formed therein;
a second substrate having a first surface and a second surface, wherein the first surface of the second substrate is bonded to the first substrate to encapsulate the microchannel; and
electrical elements formed on the second surface of the second substrate by using a metallization process, wherein the second substrate is thinned after being attached to the first substrate.

27. A kit comprising the microfluidic chip of claim 26.
